(19) United States
(12) Patent Application Publication
(10) Pub. No.: US 2021/0352622 A1
(43) Pub. Date: Nov. 11, 2021

(54) NETWORK NODE, USER EQUIPMENT AND METHOD FOR BROADCASTING BEAMFORMED SIGNALS IN A WIRELESS NETWORK

(71) Applicant: Telefonaktiebolaget LM Ericsson (publ), Stockholm (SE)

(72) Inventors: Pål FRENGER, Linköping (SE); Erik G. LARSSON, Linköping (SE); Emil BJÖRNSON, Linköping (SE); Hei Victor CHENG, Linköping (SE)

(21) Appl. No.: 17/284,523

(22) PCT Filed: Oct. 13, 2018
(86) PCT No.: PCT/SE2018/051046

§ 371 Date: Apr. 12, 2021

(51) Int. Cl. H04W 72/00; H04W 72/04; H04L 5/00

(52) U.S. Cl. CPC H04W 72/005; H04L 5/005; H04W 72/0453; H04W 72/046

(57) ABSTRACT

A method performed by a network node for broadcasting beamformed signals of a data transmission to a User Equipment (UE). For each specific data transmission from a number of data transmissions the network node allocates a set of Reference Signals, RS, for the data transmission, the number of RSs in the set of RSs being based on a measure of popularity for UEs receiving the specific data transmission. The network node sends an indication of the allocated set of SRs for each specific data transmission. The network node receives from a UE requesting a particular data transmission out of the number of data transmissions an RS from the set of RS allocated for the particular data transmission. The network node broadcasts beamformed signals of the particular data transmission. The signals are beamformed based on estimated composite channels from all UEs that transmit any RS included in the set of RS allocated for the particular data transmission.

### TECHNICAL FIELD

Embodiments herein relate to a network node, a user equipment and methods therein. In particular, they relate to broadcasting beamformed signals in a wireless communications network.

### BACKGROUND

In a typical wireless communication network, wireless devices, also known as wireless communication devices, mobile stations, stations (STA) and/or User Equipments (UE), communicate via a Local Area Network such as a WiFi network or a Radio Access Network (RAN) to one or more core networks (CN). The RAN covers a geographical area which is divided into service areas or cell areas, which may also be referred to as a beam or a beam group, with each service area or cell area being served by a radio network node such as a radio access node e.g., a Wi-Fi access point or a radio base station (RBS), which in some networks may also be denoted, for example, a NodeB, eNodeB (eNB), or gNB as denoted in 5G. A service area or cell area is a geographical area where radio coverage is provided by the radio network node. The radio network node communicates over an air interface operating on radio frequencies with the wireless device within range of the radio network node.

Specifications for the Evolved Packet System (EPS), also called a Fourth Generation (4G) network, have been completed within the 3rd Generation Partnership Project (3GPP) and this work continues in the coming 3GPP releases, for example to specify a Fifth Generation (5G) network also referred to as 5G New Radio (NR). The EPS comprises the Evolved Universal Terrestrial Radio Access Network (E-UTRAN), also known as the Long Term Evolution (LTE) radio access network, and the Evolved Packet Core (EPC), also known as System Architecture Evolution (SAE) core network. E-UTRAN/LTE is a variant of a 3GPP radio access network wherein the radio network nodes are directly connected to the EPC core network rather than to RNCs used in 3G networks. In general, in E-UTRAN/LTE the functions of a 3G RNC are distributed between the radio network nodes, e.g. eNodeBs in LTE, and the core network. As such, the RAN of an EPS has an essentially “flat” architecture comprising radio network nodes connected directly to one or more core networks, i.e. they are not connected to RNCs. To compensate for that, the E-UTRAN specification defines a direct interface between the radio network nodes, this interface being denoted the X2 interface.

Multi-antenna techniques significantly increases the data rates and reliability of a wireless communication system. The performance is in particular improved if both the transmitter and the receiver are equipped with multiple antennas, which results in a Multiple-Input Multiple-Output (MIMO) communication channel. Such systems and/or related techniques are commonly referred to as MIMO.

In addition to faster peak Internet connection speeds, 5G planning aims at higher capacity than current 4G, allowing higher number of mobile broadband users per area unit, and allowing consumption of higher or unlimited data quantities in gigabyte per month and user. This would make it feasible for a large portion of the population to stream high-definition media many hours per day with their mobile devices, when out of reach of Wi-Fi hotspots. 5G research and development also aims at improved support of machine to machine communication, also known as the Internet of things, aiming at lower cost, lower battery consumption and lower latency than 4G equipment.

The demand for mobile data traffic is growing continuously due to the enormous success of smart phones, tablets and other data traffic appliances. This has traditionally been dealt with by densifying the networks, i.e. deploying cells or network nodes more densely geographically. However, there are practical limits on how densely the macro cells can be deployed on elevated location to retain coverage. When this limit is approached, the number of simultaneously active users, such as e.g. UEs, per cell will grow substantially and need to be handled by multiplexing techniques. In the following, the terms user, terminal and UE may be used interchangeably. Massive MIMO is a key physical layer technology for dealing with a higher data traffic in future networks. Massive MIMO provides a simple and scalable way of multiplying the capacity of a radio link using multiple transmit (TX) antennas and receive (RX) antennas. In doing this multipath propagation, i.e. the signal reaching the RX antenna by several paths, may be exploited to send and receive more than one data signal simultaneously over the same radio channel. The array gain or beamforming gain from the many antennas in Massive MIMO increases the coverage and data rate per user, while the spatial multiplexing capability can be used to vastly increase the spectral efficiency to deal with high traffic from many users. With array gain is herein meant the power gain of a transmitted signal which is achieved by pre-coding a signal using the multiple TX and RX antennas in relation to a single-input single-output case, i.e. a single TX and RX antenna. With spatial multiplexing is herein meant a transmission technique in MIMO wireless communication to transmit independent data signals, often denoted as streams, to one or multiple UEs, using the same time- and frequency resources by exploiting that antennas distributed in space experience different channel realizations. With spectral efficiency is herein meant the information rate that can be transmitted over a given bandwidth in a specific communications system. Thus, the spectral efficiency is a measure of how efficiently a frequency spectrum is used by the physical layer protocol.

In certain traffic scenarios, there are large files, also referred to herein as data streams, data transmissions and content, that are of simultaneous interest to a large group of users. For example, live broadcasting of events such as sports, music, award ceremonies. Other examples include video streaming, push notifications, TV programs, TV channels, updates of popular applications, firmware updates, configuration updates or operation system updates to a massive number of machine type communication (MTC) devices or other kinds of UEs, large size public warning message broadcasts, e.g. including audio, video, images, maps, etc., system information (SI) updates in a cellular networks, etc. In these scenarios, where many users are requesting the same data simultaneously, physical layer multicasting is a promising technique to utilize the radio resources efficiently. Physical layer multicasting means that the signals are beamformed or precoded, not towards a single UE but in a way that is beneficial to the current set of active UEs, which are simultaneously requesting the same data. With beamforming is herein meant a signal processing technique used for directional signal transmission or reception. This is achieved by combining elements in an antenna array in such a way that signals at particular locations experience constructive interference while others experience destructive interference. With precoding is herein meant a generalized type of beamforming supporting multiple-stream transmissions in multiple-antenna communications e.g. to maximize the throughput of the system or to ensure good signal reception at certain locations or in an area. In some cases, different streams may be intended for different UEs while in other cases some stream or streams may be intended for multiple UEs. The gain over traditional omni-directional transmission, where the data is broadcasted into the cell without adapting the directivity of the signal to the channels of the receiving UE, may be significant. This is particularly true for the UEs with the most unfortunate channel conditions. The combination of Time Division Duplex (TDD) massive MIMO and physical layer multicasting may help to increase the spectral efficiency further, by assigning the UEs within the same multicasting group with the same pilot sequence and thereby reduce the overhead for channel estimation. TDD refers herein to duplex communication where uplink (UL) is separated from downlink (DL) by the allocation of different time slots in the same frequency band.

In traditional multicasting scenarios, the signal of interest is broadcasted omni-directionally, or according to a fixed radiation pattern of the antenna. Hence, a large portion of the energy of the signal does not reach any desired UE. Instead, unwanted interference for other potential UEs in the surrounding environment is created. When network nodes are equipped with multiple antennas, physical layer multicasting provides the ability of joint beamforming to the multiple UEs of interest.

WO 2014105773 A1 discloses a method for multicasting in massive MIMO systems where a unique pilot sequence is assigned to the transmission of a specific content. This method is composed of the following steps:

1) The base station assigns a unique orthogonal pilot sequence to each content source and informs the UEs about the pilot assignment, e.g. using broadcasting.

2) The UEs requesting the same content send the corresponding pilot sequences to the base station simultaneously.

3) The base station estimates the composite channel of the requesting UEs and beamforms through this composite channel.

However, as the number of UEs requesting a specific content increases, the beamforming gain towards each UE decreases. The relation is inversely proportional. Eventually there is no more beamforming gain and the performance will be degraded to the same level as that of omni-directional broadcasting.

An alternative strategy is to allocate one pilot sequence per UE and send replicas or copies of the data to the UEs using conventional multi-user transmission, as if the data was different for every UE. However, the number of orthogonal pilot sequences, and thereby the number of UEs, is limited by the size of the channel coherence interval. With channel coherence interval is herein meant the time duration over which the channel is assumed to be invariant, or approximately invariant. This leads to a large reduction in spectral efficiency due to the pilot sequence overhead in crowded cells. If the number of UEs is larger than the number of channel uses per coherence interval this method cannot be used at all. Furthermore, in this method a connecting UE need to go through a configuration procedure, e.g. a radio-resource configuration protocol, to be assigned a user-specific pilot sequence.

### SUMMARY

An object of embodiments herein is to improve the performance of a wireless communications network, broadcasting beamformed data transmissions to UEs.

According to a first aspect of embodiments herein, the object is achieved by a method performed by a network node for broadcasting beamformed signals of a data transmission to a User Equipment, UE. The network node and the UE operate in a wireless communication network.

For each specific data transmission out of a number of data transmissions, the network node allocates a set of Reference Signals, RS, for the data transmission. The number of RSs in the set of RSs is based on a measure of popularity for UEs receiving the specific data transmission. The network node sends to UEs, an indication of the allocated set of SRs for each specific data transmission. The network node then receives from a UE requesting a particular data transmission out of the number of data transmissions, an RS out of the set of RS allocated for the particular data transmission. The network node thereafter broadcasts beamformed signals of the particular data transmission. The signals are beamformed based on estimated composite channels from all UEs that transmit any RS comprised in the set of RS allocated for the particular data transmission.

According to a second aspect of embodiments herein, the object is achieved by a method performed by a User Equipment, UE, for receiving broadcasted beamformed signals of a data transmission from a network node. The UE and the network node operate in a wireless communication network.

For each specific data transmission out of a number of data transmissions, the UE receives from the network node, an indication of an allocated set of Reference Signals, RS for the data transmission. The number of RS in the set of RS is based on a measure of popularity for UEs receiving the specific data transmission. The UE sends to the network node, an RS out of the set of RSs allocated for a particular requested data transmission out of the number of data transmissions. The UE then receives, from the network node, broadcasted beamformed signals of the particular data transmission. The signals are beamformed based on estimated composite channels from all UEs that transmit any RS comprised in the set of RS allocated for the particular data transmission.

According to a third aspect of embodiments herein, the object is achieved by a network node for broadcasting beamformed signals of a data transmission to a User Equipment, UE. The network node and the UE is adapted to operate in a wireless communication network. The network node is configured to:
For each specific data transmission out of a number of data transmissions, allocate a set of Reference Signals, RS, for the data transmission. The number of RS in the set of RS is adapted to be based on a measure of popularity for UEs receiving the specific data transmission.
Send to UEs an indication of the allocated set of SRs for each specific data transmission.
Receive from a UE requesting a particular data transmission out of the number of data transmissions, an RS out of the set of RSs allocated for the particular data transmission.
Broadcast beamformed signals of the particular data transmission, which signals are adapted to be beamformed based on estimated composite channels from all UEs that transmit any RS comprised in the set of RS allocated for the particular data transmission.

According to a fourth aspect of embodiments herein, the object is achieved by a User Equipment, UE, for receiving broadcasted beamformed signals of a data transmission from a network node. The UE and the network node are adapted to operate in a wireless communication network. The UE is configured to:
For each specific data transmission out of a number of data transmissions, receive from the network node, an indication of an allocated set of Reference Signals, RS, for the data transmission. The number of RS in the set of RSs is adapted to be based on a measure of popularity for UEs receiving the specific data transmission.
Send to the network node, an RS out of the set of RSs allocated for a particular requested data transmission out of the number of data transmissions.
Receive from the network node, broadcasted beamformed signals of the particular data transmission, which signals are adapted to be beamformed based on estimated composite channels from all UEs that transmit any RS comprised in the set of RS allocated for the particular data transmission.

Since a certain set of RS is allocated for certain popular data transmissions instead of certain UEs, it is achieved an effect of beamforming array gain. This in turn improves the performance of the wireless communications network, broadcasting beamformed data transmissions to UEs.

A further advantage is that embodiments provided herein may be implemented using grant-free multiple access by reserving certain RS for certain popular data transmissions, and since this does not require explicit signaling for configuring RS transmission of each individual UE that want to receive a certain data transmission the downlink control signaling overhead can be reduced. This is not possible in beamformed transmission according to prior art, where RS are assigned to particular UEs and not to particular data transmissions. Other advantages are e.g. increased spectral efficiency and reduced overhead cost for RS training, e.g. pilot training, compared to prior art.

### BRIEF DESCRIPTION OF THE FIGURES

FIG. 1 is a schematic diagram illustrating embodiments of a network.

FIG. 2 is a flowchart depicting embodiments of a method in a network node.

FIG. 3 is a flowchart depicting embodiments of a method in a user equipment.

FIG. 4 is a diagram illustrating embodiments herein.

FIG. 5 is a diagram illustrating embodiments herein.

FIGS. 6a and b are schematic block diagrams illustrating embodiments of a network node.

FIGS. 7a and b are schematic block diagrams illustrating embodiments of a user equipment.

FIG. 8 schematically illustrates a telecommunication network connected via an intermediate network to a host computer.

FIG. 9 is a generalized block diagram of a host computer communicating via a base station with a user equipment over a partially wireless connection.

FIGS. 10-13 are flowcharts illustrating methods implemented in a communication system including a host computer, a base station and a user equipment.

### DETAILED DESCRIPTION

The project leading to this application has received funding from the European Union's Horizon 2020 research and innovation programme under grant agreement No 641985.

According to example embodiments herein methods for broadcasting beamformed signals, e.g. multicasting, of data transmissions is provided, wherein information regarding the popularity distribution associated with specific data transmissions is used in order to enhance the performance of a wireless communication network. The data transmission may also be referred to as content and may e.g. be live broadcasting of events such as sports, music or award ceremonies. Other examples include video streaming, push notifications, TV programs, TV channels, and updates of popular applications. Based on a popularity distribution, the number of Reference Signals (RS), e.g. pilot sequences, reserved for different data transmissions is predetermined.

In some embodiments, popular data transmissions requested by groups of UEs are stored in network nodes, e.g. in base stations, and the broadcasted beamformed signals are applied to deliver the data transmission to the UEs from the network nodes. The network nodes may e.g. be cache-enabled, i.e. they have the capability of locally storing certain information in a cache memory and may read from the local cache memory instead of obtaining the information again from another node, e.g. distant server in the network, when said information is requested by a UE or a group of UEs.

According to embodiments herein the RSs are allocated for each data transmission based on the popularity information, and not allocated to the UEs. This makes the provided embodiment scalable with the number of UEs and fits the demand of the future massive connectivity.

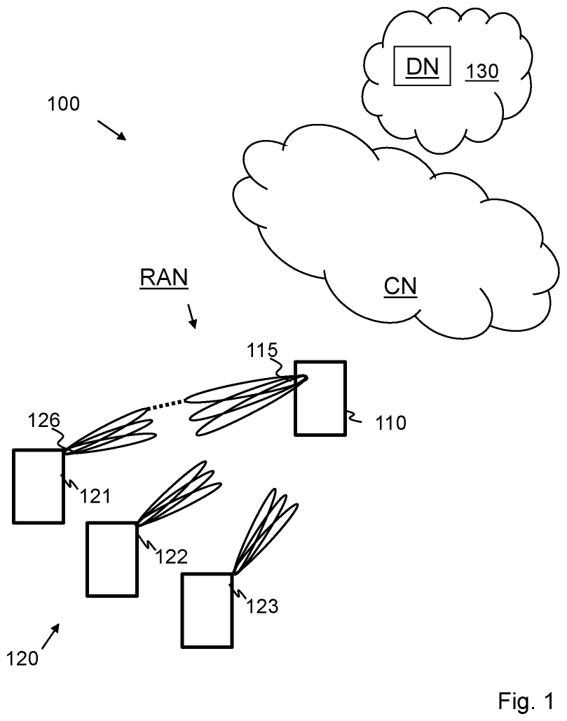

FIG. 1 is a schematic overview depicting a wireless communications network 100 wherein embodiments herein may be implemented. The wireless communications network 100 comprises one or more RANs and one or more CNs. The wireless communications network 100 may use 5G NR but may further use a number of other different technologies, such as, Wi-Fi, (LTE), LTE-Advanced, Wideband Code Division Multiple Access (WCDMA), Global System for Mobile communications/enhanced Data rate for GSM Evolution (GSM/EDGE), Worldwide Interoperability for Microwave Access (WiMax), or Ultra Mobile Broadband (UMB), just to mention a few possible implementations.

Network nodes such as a network node 110 operate in the wireless communications network 100, providing radio coverage by means of antenna beams, referred to as beams herein. The network node 110 provides a number of beams 115 and may use these beams for communicating with e.g. one or more User Equipment, UEs 120, 121, 122, 123, see below. The network node 110 is a radio node such as e.g. a base station or a UE. The network node 110 is configured to broadcast beamformed signals of data transmissions to the UEs 120, 121, 122, 123.

The network node 110 provides radio coverage over a geographical area by means of the antenna beams. The geographical area may be referred to as a cell, a service area, beam or a group of beams. The network node 110 may in this case be a transmission and reception point e.g. a radio access network node such as a base station, e.g. a radio base station such as a NodeB, an evolved Node B (eNB, eNode B), an NR Node B (gNB), a base transceiver station, a radio remote unit, an Access Point Base Station, a base station router, a transmission arrangement of a radio base station, a stand-alone access point, a Wireless Local Area Network (WLAN) access point, an Access Point Station (AP STA), an access controller, a UE acting as an access point or a peer in a Device to Device (D2D) communication, or any other network unit capable of communicating with a UE 120 within the cell served by network node 110 depending e.g. on the radio access technology and terminology used.

A number of UEs 120, 121, 122, 123 operate in the wireless communications network 100.

Each of the UEs, 120, 120, 121, 122, 123 may e.g. be an NR device, a mobile station, a wireless terminal, an NB-IoT device, an eMTC device, a CAT-M device, a WiFi device, an LTE device and an a non-access point (non-AP) STA, a STA, that communicates via a base station such as e.g. the network node 110, one or more Access Networks (AN), e.g. RAN, to one or more core networks (CN). It should be understood by the skilled in the art that the UE relates to a non-limiting term which means any UE, terminal, user terminal, wireless communication terminal, user equipment, (D2D) terminal, or node e.g. smart phone, laptop, mobile phone, sensor, relay, mobile tablets or even a small base station communicating within a cell.

The UEs, 120, 120, 121, 122, 123 are consumers of data transmissions such as: live broadcasting of events such as sports, music or award ceremonies. Other examples include video streaming, push notifications, TV programs, TV channels, and updates of popular applications. In an example scenario, the UEs 121 are receiver of a specific data transmission referred to as A, the UEs 122 are receiver of a specific data transmission referred to as B, and the UEs 123 are receiver of a specific data transmission referred to as C.

Some methods according to embodiments herein are performed by the network node 110. As an alternative, a Distributed Node DN and functionality, e.g. comprised in a cloud 130 as shown in FIG. 1 may be used for performing or partly performing the methods.

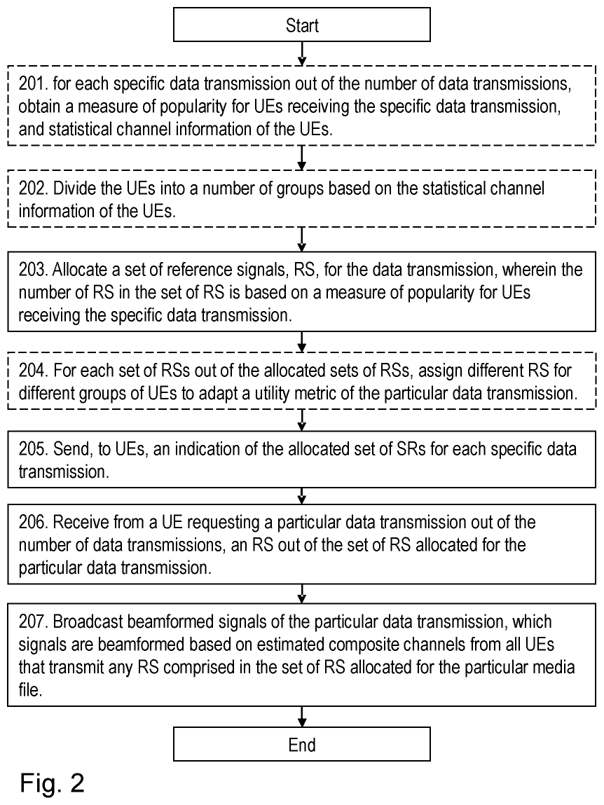

Example embodiments of a method performed by the network node 110 for broadcasting beamformed signals of a data transmission to a User Equipment, UE, 121, will now be described with reference to a flowchart depicted in FIG. 2. As mentioned above, the network node 110 and UE 121 operate in the wireless communication network 100.

The method comprises the following actions, which actions may be performed in any suitable order. Dashed boxes represent optional method steps.

Action 201.

To improve the performance of the wireless communications network 100 broadcasting beamformed data transmissions to UEs, embodiments herein provide a scheme that utilizes knowledge of the popularity of the different data transmissions—By allocating a number of RSs to a specific data transmission an improvement over both the omni-directional broadcasting and the composite channel beamforming described above is achieved. Since, beamforming gain will diminish with the number of UEs requesting a data transmission, the allocation of the RSs is according to embodiments herein based upon the popularity of the data transmission such as e.g. data content amongst the UEs 120 in the network.

The network node 110 provides a number of data transmissions, which in the below example comprises three specific data transmissions, referred to as A, B and C. In the history they have been received, also referred to as consumed, by the number of UEs 120. The network node 110 first obtains information relating to popularity of the different available data transmissions consumed by the UEs 120. This may be achieved e.g. through prediction, machine learning methods, using observed statistics while serving active users or combinations of these methods.

Thus, according to an example scenario the network node 110 may for each specific data transmission out of the number of data transmissions A, B, C, obtain a measure of popularity for UEs 120 receiving the specific data transmission A, B, C. The network node 110 may also obtain statistical channel information of the UEs 120. The popularity may e.g. be expressed through a relative popularity distribution of the different data transmissions. As another example, the measure of popularity for UEs 120 receiving the specific data transmission may e.g. be based on how large fraction out of all of the UEs 120 that are requesting the specific data transmission. The statistical channel information of the UEs 120 may e.g. be based on the path loss, or path gain, of the channels for the specific UEs 121, 122, 123.

Action 202

In addition, according to some example scenarios, the UEs 120 may be grouped such that UEs 120 utilizing the same RS to receive the same data transmission will have a similar channel quality. The channel quality may e.g. support a certain bit-rate, which may be associated with e.g. a data packet size, modulation order, and channel coding rate in a given radio resources. Hence, in this scenario, the bit-rate of the broadcast data transmission does not have to be adapted to the worst UE 121 in the whole UE population 120. Instead, the bit-rate need only be adapted to the worst UE 121 in each group of UEs 120. A group of UEs 120 may also be designated a pilot group. With worst UE 121 is herein meant the UE who has a channel quality that supports the lowest bit-rate among a group of UEs. The UEs may be divided into a number of different groups, in the example scenario herein, the number of UEs are divided into two groups, referred to as a and b.

Thus, in the example scenario described in conjunction with action 201 above, the network node 110 may divide the UEs 120 into a number of groups a, b, based on the statistical channel information of the UEs 120.

Action 203

Based on the measure of popularity for UEs 120 receiving the specific data transmission A, B, C, the network node 110 then allocates different numbers of reference signals, e.g. pilot sequences, for each data transmission. This is referred to as a set of RS. It should be noted that the set of RS may comprise one or more RS. In the example scenario a set of RS referred to as P1 is allocated to the data transmission A, resulting in A-P1, a set of RS referred to as P2 is allocated to the data transmission B, resulting in B-P2, and a set of RS referred to as P3 is allocated to the data transmission C, resulting in C-P3.

Thus, for each specific data transmission out of a number of data transmissions A, B, C, the network node 110 allocates a set of Reference Signals, RS, P1, P2, P3 for the data transmission A-P1, B-P2, C-P3, wherein the number of RS in the set of RS is based on a measure of popularity for UEs 120 receiving the specific data transmission.

As an example, the network node 110 may allocate the RSs P1, P2, P3 for the data transmission A-P1, B-P2, C-P3 such that a utility metric of the particular data transmission A, B, C is adapted. Thus, the allocation of the RS P1, P2, P3 may be performed to adapt a certain utility metric, e.g. to optimize the utility metric in some manner. In some embodiments, the allocation of RS in each set the RS P1, P2, P3 may be performed to adapt a certain utility metric. The utility metric may for example be the average weighted max-min spectral efficiency for the delivery of the data transmission. With max-min spectral efficiency is herein meant that the transmission is optimized to maximize the performance of the UE experiencing the lowest spectral efficiency within a group of UEs. Another example of a utility metric may e.g. the percentage of UEs (120) that will be able to successfully decode the data transmission.

The utility metric may further comprise maximizing the sum throughput, the average or median throughput, or maximizing a certain percentile of the UE throughput distribution, etc.

Action 204

According to the example scenario described in conjunction with action 201 and 202 above, for each set of RSs out of the allocated sets of RSs A-P1, B-P2, C-P3, the network node 110 may assign different RS for different groups of UEs A-P1a P1b, B-P2a P2b, C-P3a P3b to adapt a utility metric of the particular data transmission A, B, C.

Thus, the assignment of RSs to the different groups of UEs 120 may be performed in order to adapt a utility metric, e.g. optimize a certain utility metric. The utility metric may here be the same utility metric as described in action 403 above.

In an example scenario, the UEs 121 are receiver of a specific data transmission referred to as A, the UEs 122 are receiver of a specific data transmission referred to as B, and the UEs 123 are receiver of a specific data transmission referred to as C.

As mentioned above in Action 202, the network node 110 may have divided the UEs 120 into groups based on the statistical channel information of the UEs 120. In these embodiments, e.g. for each specific data transmission such as each of A, B and C, dividing the UEs 120 into a number of groups, e.g. a and b. The number of groups corresponds to the number of RS in the set of RS allocated for the specific data transmission. Thereafter the network node 110 may assign each group a, b one of the RS in the set of RS P1, P2, P3 allocated for the specific data transmission A, B and C. E.g. For the specific data transmission A, dividing the number of UEs 121 into a number of groups, e.g. a, and b. The number of groups, in this example two groups, corresponds to the number of RS in the set of RS P1 allocated for the specific data transmission A. I.e. for specific data transmission A: allocate two RS: P1a and P1b, in the set of RS P1.

The network node 110 may as another example divide the number of UEs 120 into groups based on their bit-rate requirements. This may e.g. be done by, for each specific data transmission, dividing the UEs 120 into a number of groups a, b corresponding to a number of different rate requirements of the UEs 120 requesting the specific data transmission. Thereafter the network node 110 may assign each group a, b one of the RS in the set of RS P1, P2, P3 allocated for the specific data transmission.

The network node 110 may as a further example divide the UEs 120 into groups according to channel quality and the physical layer cost of providing a certain requested bit-rate.

Action 205

In order for the UEs 120, 121, 122, 123 to know the allocation of RSs the network node 110 sends to UEs 121, 122, 123 an indication of the allocated set of SRs for each specific data transmission A-P1, B-P2, C-P3. The network node 110 may e.g. broadcast the indication or send the indication to specific UEs 121, 122, 123 through dedicated signaling.

Action 206

The UEs 120, 121, 122, 123 have now received information regarding the RSs reserved for the different data transmissions. When a UE 121 wants to get access to one of the data transmissions such as A, it transmits one of the RSs in the set of RS P1 reserved for that specific data transmission, see action 303 below.

Thus, the network node 110 thus receives from a UE 121 requesting a particular data transmission A out of the number of data transmissions, an RS P1 out of the set of RS P1, P2, P3 allocated for the particular data transmission A.

Action 207

The network node 110 then transmits beamformed signals of the data transmission associated with the specific RS received. The network node 110 may transmit the signals using a suitable transmission rate based on the estimated composite channels from all users that transmit the same RS.

Thus, the network node 110 broadcasts beamformed signals of the particular data transmission A. The broadcasted signals are beamformed based on estimated composite channels from all UEs 121 that transmit any RS P1 comprised in the set of RS P1, P2, P3 allocated for the particular data transmission A. The beamforming may be a conjugate beamforming based on the estimated composite channels. With conjugate beamforming is herein meant that pre-coding weights are calculated as the complex-conjugate of the estimated channel.

In embodiments herein, one data transmission is associated with a varying number of RSs, e.g. pilot sequences, and therefore have different number of intended beamformers. With different beamformers in this context it is meant different pre-coding parameters resulting in different beam-shapes of the MIMO system.

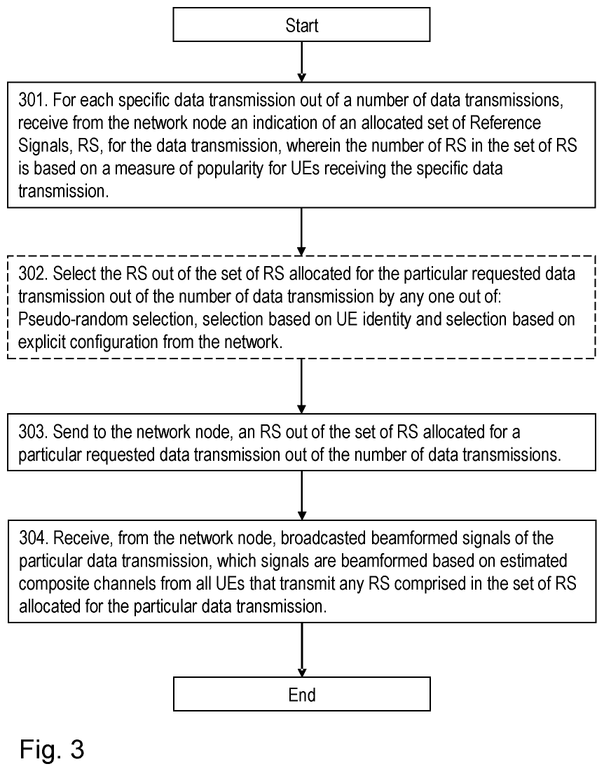

Example embodiments of a method performed by the UE 121 for receiving broadcasted beamformed signals of a data transmission from the network node 110, will now be described with reference to a flowchart depicted in FIG. 3. As mentioned above, the UE 121 and the network node 110 operate in the wireless communication network 100. The method in the UE 121 relates to the method in the network node 110 described above.

The method comprises the following actions, which actions may be performed in any suitable order. Dashed boxes represent optional method steps.

Action 301

According to the example embodiments described herein, the UE 121 want to receive a specific data transmission A out of the number of data transmissions A, B, C. The specific data transmission may e.g. be a popular sports game being streamed live. In order to receive this data transmission A, the UE 121 must know which RS that is associated with the data transmission A.

Thus, for each specific data transmission A-P1, B-P2, C-P3 out of a number of data transmissions A, B, C, the UE 121 receives from the network node 110 an indication of an allocated set of Reference Signals, RS P1, P2, P3 for the data transmission A-P1, B-P2, C-P3, wherein the number of RS in the set of RS is based on a measure of popularity for UEs 120 receiving the specific data transmission,

The allocated set of Reference Signals, RS P1, P2, P3 for the data transmission A-P1, B-P2, C-P3 may be allocated such that a utility metric of the particular data transmission A, B, C is adapted.

Action 302

The UE 121 may select the RS P1 out of the set of RS P1, P2, P3 allocated for the particular requested data transmission A out of the number of data transmissions A, B, C by any one out of:

Pseudo-random selection,

Selection based on UE identity, and

Selection based on explicit configuration from the network.

Pseudo-random selection means that the selection is made using a random number generator function implemented using e.g. software or hardware.

The selection based on UE identity may e.g. be based on the Random Network Temporary Identifier (RNTI), the International Mobile Subscriber Identity (IMSI), etc.

The selection based on explicit configuration may be performed using some other kind of RS assignment function for the selection.

Action 303

To receive the requested data transmission A, the UE 121 must let the network node 110 know which data transmission A out of the number of data transmissions A, B, C that the UE 121 requests.

Thus, the UE 121 sends to the network node 110, an RS P1 out of the set of RS P1, P2, P3 allocated for a particular requested data transmission A out of the number of data transmissions A, B, C.

Action 304

The network node 110 will now broadcast beamformed signals of the data transmission A to all the UEs 121, 122, 123 having requested the specific transmission A by transmitting an RS P1, associated with the data transmission A. This broadcast is received by the UE 121.

Thus, the UE 121 receives, from the network node 110, broadcasted beamformed signals of the particular data transmission A, which signals are beamformed based on estimated composite channels from all UEs 121 that transmit any RS P1 comprised in the set of RS P1, P2, P3 allocated for the particular data transmission A.

The method described above will now be further explained and exemplified.

Method A

The provided method for broadcasting beamformed signals of a data transmission to a UE 121 will now be further explained through an example scenario. According to the scenario the network node 110 comprises at least one antenna. The network node 110 has obtained information regarding the popularity of at least one data transmission A in this example referred to as content file (fᵢ). The popularity information fᵢ e.g. measure of popularity fᵢ may relate to how popular the specific data transmission is amongst the UEs 120 in the wireless network 110. The popularity information may have been obtained in a previous step and may e.g. be represented by a popularity index fᵢ. As mention above, the measure of popularity for the specific data transmission A amongst the UEs 120 receiving the specific data transmission A may e.g. be based on how large fraction out of all of the UEs 120 that are requesting the specific data transmission. According to the scenario, at least one UE 121 requests the data transmission A also referred to as the data from the aforementioned content file A. The example method according to this example scenario may then involve the following steps (not shown):
Step 1) The network node 110 e.g. determines e.g. by computing, and allocates, a set of RSs P1, P2, P3 for the data transmission A-P1, B-P2, C-P3, wherein the number of RS in the set of RS is based on a measure of popularity for UEs 120 receiving the specific data transmission. The sets of RS P1, P2, P3 may e.g. be pilot sequences. Thus, in some examples, the network node 110 computes a pilot allotment scheme based on a popularity index. The pilot allotment scheme may be computed in order to adapt a given utility metric, e.g. to optimize the metric. See below for examples of the utility metric.
Step 2) The network node 110 sends to UEs 121, 122, 123 an indication of the allocated sets of SR for each specific data transmission A-P1, B-P2, C-P3. Thus, the network node 110 may send the pilot allotment information to the UEs 121, 122, 123 e.g. via broadcast or dedicated signalling.
Step 3) Each of the UEs 121, sends to the network node 110, an RS P1 out of the set of RS P1, P2, P3 allocated for a particular requested data transmission A out of the number of data transmissions. Thus, each UE 121 may transmit one of the pilot sequences associated with the content file fᵢ they are requesting.
Step 4) The network node 110 estimates the composite channels from all the UEs 121 that send the same RS, e.g. the same pilot sequences.
Step 5) The network node 110 then beamforms the requested content or data transmission to the UEs 121 through the estimated composite channels. Thus, the broadcasted signals are beamformed based on estimated composite channels from all UEs 121 that transmit any RS P1 comprised in the set of RS P1, P2, P3 allocated for the particular data transmission A.

In step 1 above, the allocation of RSs may be performed based on the following, where T₁ to T_{K} are given or predetermined thresholds of increasing value representing increasing data transmission popularity:
If the popularity information fᵢ of a specific data transmission is below a minimum threshold, i.e. T₁>fᵢ, the popularity is low. Then the network node 110 does not reserve any set of RS for the data transmission. UEs 120 requesting this content will be assigned dedicated SRs, e.g. pilot sequences, as for conventional dedicated data transmission.
If T_{K}>fᵢ>T_{K-1} for some k∈[2,K], then the network node 110 allocates k RS in the set of RS to the specific data transmission associated with that specific popularity index.
If fᵢ>T_{K}, there are too many UEs 120 interested in this data transmission, i.e. there are too many subscriptions for this content. In this case, reserving more RS in the set of RS, such as pilot sequences, does not help. Therefore, the network node 110 may perform omni-directional broadcasting in this case.

For the scenario above, suppose the number of available orthogonal sets of RS e.g. pilot sequences is K̅ then the network node 110 allocates, e.g. determined by computing, the thresholds T₁ to T_{K} to adapt, e.g. maximize, a certain utility metric, by taking K̅ into account. One example of a utility metric is the average weighted max-min spectral efficiency for the delivery of the data transmission, assuming a predetermined set of sample UE 120 locations. The average may be computed with respect to a random subset of the UE 120 locations and the weights are selected based on the data transmission popularity fᵢ. Another example of a utility metric is the percentage of UEs 120, in a sample set of UE 120 locations, that will be able to successfully decode the data transmission. The percentage may be weighted by the data transmission popularity fᵢ.

Method B

In a variation of the proposed method detailed above, where extra information regarding the statistical channel properties, such as e.g. the pathloss, of the UEs 120 are available, some steps may be added. This variation may be referred to as method B. The statistical channel information may then be used for dividing UEs 120 into groups, i.e. grouping UEs 120, to further adapt, e.g. maximize, the predefined utility metric. For example, when max-min fairness utility is used as metric, then the specific grouping strategy may be:
Order the UEs 120 in decreasing or increasing order based on their statistical channel information. For example, the UE 121, 122, 123 having the lowest path loss amongst the UEs 120 may be ordered at the top of the list, followed by the UE 121, 122, 123 having the next lowest path loss etc.
If there are Kᵢ RS reserved for this data transmission and Nᵢ UEs 120 requesting this data transmission, then divide the UEs 120 so that the first Nᵢ/Kᵢ UEs 121, 122, 123 are placed or grouped in a first group, and the next Nᵢ/Kᵢ UEs 121, 122, 123 are placed in a second group, and so on.
Assign one RS, e.g. a pilot sequence, to each group and then broadcast this information to the UEs 121, 122, 123 in that group.

Thus, expressed differently, the network node 110 may divide the UEs 120 into groups by, for each specific data transmission, dividing the UEs 120 into a number of groups a, b corresponding to the number of RS P1, P2, P3 allocated for the specific data transmission divided by the number of UEs 120 requesting the specific data transmission. Thereafter the network node 110 may assign each group a, b one of the RS P1, P2, P3 allocated for the specific data transmission.

This variation, i.e. method B, may also be applied to serve UEs 120 requesting the same data transmission but with different rate requirements. A possible grouping strategy may in this case be:
Reserve Qᵢ different RSs, e.g. pilot sequences, for the data transmission or content i, where Qᵢ is the number of quality levels, i.e. the number of different rate requirements obtained.
Assign one RS of the set of RS, e.g. a pilot sequence, to each group and broadcast this information to the UEs 121, 122, 123 in that group.
UEs 121, 122, 123 transmit their corresponding RS according to the quality level they desire.

Expressed differently, the network node 110 may divide the UEs 120 into groups based on their bit-rate requirements. This may e.g. be done by, for each specific data transmission, dividing the UEs 120 into a number of groups a, b corresponding to a number of different rate requirements of the UEs 120 requesting the specific data transmission. Thereafter the network node 110 may assign each group a, b one of the RS P1, P2, P3 allocated for the specific data transmission.

Comparison

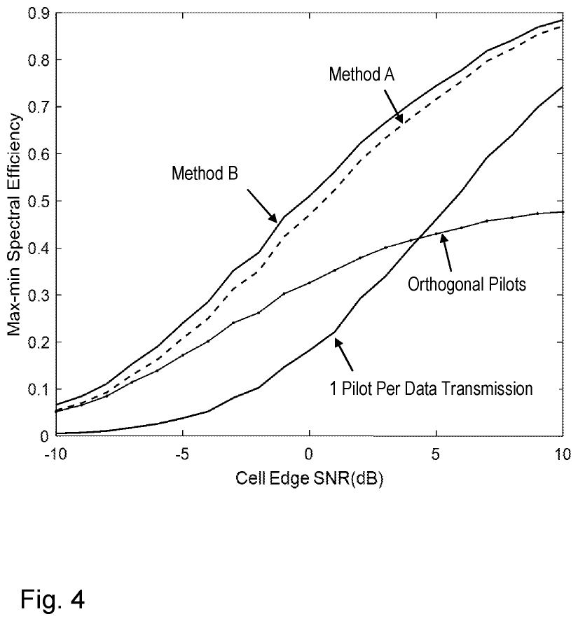

FIG. 4 illustrates an example of embodiments herein in a single-cell massive MIMO system with a cell radius of 500 m when compared to prior art. The max-min spectral efficiency is plotted on the y-axis versus the cell edge Signal-to-Noise-Ratio (SNR) in dB on the x-axis. The 1 Pilot Per Data Transmission scheme is the method described in prior art documents WO 2014105773 A1, where only one pilot sequence is reserved for the data transmission, a network node estimates a composite channel for UEs and applies conjugate beamforming based on the estimated composite channel. Orthogonal Pilots is a method where dedicated pilot sequences are provided for each UE, so that the file or data transmission is duplicated and transmitted separately to each UE.

According to embodiments of Method A, there is one popular data transmission, content 1 in a set of RS such as pilot sequences reserved for content 1 that is optimized for, between 1 and 100, and the UEs 120 send one of the RS in the asset of RS e.g. pilot sequences in a random fashion. FIG. 4 discloses a comparison between the above mentioned prior art with the above described Method A and also Method B which is a variation of Method A also described above. Thus, in Method B the network node 110 makes use of statistical channel information, e.g. pathloss, to divide the UEs 120 requesting content 1 into two different groups based on their large-scale fading parameters. UEs 120 with better channels are grouped in one group, e.g. a, and the remaining UEs 120 in a different group, e.g. b. Each group is assigned a different RS in one of the sets of RS, e.g. a different pilot sequence. For both Method A and Method B, the network node 110 estimates the composite channel, which composition will e.g. depend on the UE 120 grouping, from the received set of RS such as pilot sequences and applies the conjugate beamforming based on the estimated composite channel.

Note that Method A may also be viewed as a random grouping of the UEs 120. From FIG. 4 it may be seen that both embodiments Method A and Method B respectively, outperforms the scheme of 1 Pilot Per Data Transmission as well as the Orthogonal Pilots scheme which are duplicated and delivered to the UEs 120 with different beamformers.

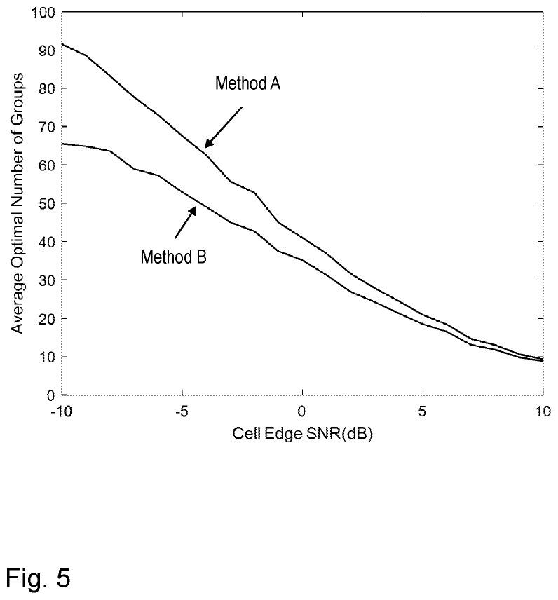

FIG. 5 illustrates the example of FIG. 4 but here highlighting the optimal number of groups. In FIG. 5, the y-axis show the average optimal number of groups and the x-axis show the cell edge SNR in dB. From FIG. 5 it may be observed that when the SNR is low, it is better to have more groups. This enhances the channel estimation quality. When the SNR increases, more UEs 120 may be in the same group. Thus, less pilot sequences are needed. It should be noted that the provided Method B, where UEs 120 are placed in groups according to the statistical channel information, e.g. pathloss, results in fewer pilot sequences being used compared to the provided Method A, which correspond to random UE 120 grouping. This may be further translated into increased rate in case the reduced RS, e.g. pilot signal, overhead resources may instead be utilized for data transmission, which is not done in this example.

Hence, there is a non-trivial tradeoff in the allotment of RS, e.g. pilot sequences, to different data transmission e.g. content. The popularity of the content determines the the number of RS in the set of RS, e.g. pilot sequences, that are assigned to that specific data transmission. Thus, the RS allotment will change as the popularity changes. The allotment is also determined by the SNR, which thus determine how many UEs 120 may share a particular SR while still receiving the desired performance.

Embodiments herein do not only increase the performance, but may also provide a greater flexibility than the state-of-the-art solutions. The flexibility comes from the fact that the UEs 120 are divided into groups where each group may have a different beamforming and power control. This allows for delivering different rates to different UEs 120 depending on their rate requirements. Allocation of different rates to different groups is possible by adapting the beamforming and power control to satisfy their specific requirements. One use case where this flexibility is useful may be video streaming, where different UEs 120 have different requirements for the video quality. UEs 120 with higher rate requirements, e.g. due to larger device screen size, service subscription level, etc. are grouped into one group, while the UEs 120 requiring a basic, e.g. lower, rate are grouped in another group. Even if the UEs 120 would request the same video in the application layer, the UEs 120 are assigned to different groups with different rate requirements in the physical layer depending on which video resolution is requested.

UEs 120 may also be grouped according to channel quality and the physical layer cost of providing a certain bit-rate.

In some embodiments, the broadcasting may be carried out jointly from multiple network nodes 110. Thus, the same data transmission is allocated the RS in multiple cells. UEs 120 at the cell edge may benefit particularly from this strategy since they might receive signal components of similar magnitude from multiple network nodes 110.

In some embodiments, when the network node 110 informs the UEs 120 of which RS or set of RS such as pilot signals to use, it also provides a power control coefficient to be used when transmitting the RS. In other embodiments, there is a predefined power control policy that the user applies when transmitting the RS.

In some embodiments, the network node 110 periodically broadcasts a list of popular files, enabling the UEs 120, 121, 122, 123 to request them automatically. In other embodiments, it is the network node 110 that identifies that the UE 121 requests one of the popular content files.

By following the provided scheme, there is no risk for RS overhead bottlenecks which is common in conventional one-RS-per-UE beamforming. Furthermore, the problem of reduced beamforming gain when serving many UEs by multicasting is mitigated.

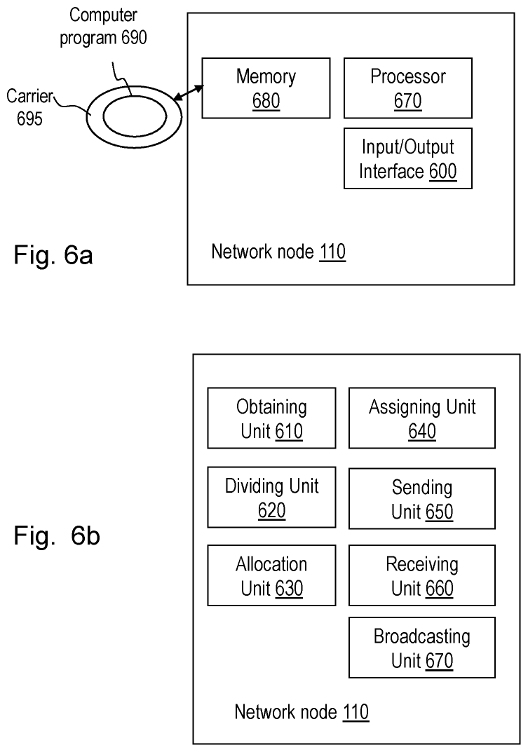

To perform the method actions above for broadcasting beamformed signals of a data transmission to a UE 121 the network node 110 may comprise the arrangement depicted in FIGS. 6a and 6b. As mentioned above, the network node 110 and UE 121 are adapted to operate in a wireless communication network 100.

The network node 110 may comprise an input and output interface 600 configured to communicate, e.g. with the UEs 121, 122, 123. The input and output interface may comprise a wireless receiver (not shown) and a wireless transmitter (not shown).

The network node 110 may be configured to, for each specific data transmission out of the number of data transmissions A, B, C, e.g. by means of an obtaining unit 610 in the network node 110, obtain a measure of popularity for UEs 120 receiving the specific data transmission A, B, C. The network node 110 may also obtain statistical channel information of the UEs 120.

The network node 110 may in this case further be configured to, e.g. by means of a dividing unit 620 in the network node 110, divide the UEs 120 into a number of groups a, b based on the statistical channel information of the UEs 120.

The network node 110 is configured to, for each specific data transmission out of a number of data transmissions A, B, C, e.g. by means of an allocating unit 630 in the network node 110, allocate a set of Reference Signals, RS P1, P2, P3 for the data transmission A-P1, B-P2, C-P3. The number of RS in the set of RS is adapted to be based on a measure of popularity for UEs 120 receiving the specific data transmission.

The network node 110 may be configured to allocate a set of Reference Signals, RS P1, P2, P3 for the data transmission A-P1, B-P2, C-P3, by further being configured to allocate the RSs P1, P2, P3 for the data transmission A-P1, B-P2, C-P3 such that a utility metric of the particular data transmission A, B, C is adapted.

The network node 110 may, for each set of RSs out of the allocated sets of RSs A-P1, B-P2, C-P3, e.g. by means of an assigning unit 640 in the network node 110, assign different RS for different groups of UEs A-P1a P1b, B-P2a P2b, C-P3a P3b to adapt a utility metric of the particular data transmission A, B, C.

The network node 110 is further configure to, e.g. by means of a sending unit 650 in the network node 110, send to UEs 121, 122, 123 an indication of the allocated set of SRs for each specific data transmission A-P1, B-P2, C-P3.

The network node 110 is further configure to, e.g. by means of a receiving unit 660 in the network node 110, receive from a UE 121 requesting a particular data transmission A out of the number of data transmissions, an RS P1 out of the set of RS P1, P2, P3 allocated for the particular data transmission A.

The network node 110 is further configured to, e.g. by means of a broadcasting unit 670 in the network node 110, broadcast beamformed signals of the particular data transmission A. The signals are adapted to be beamformed based on estimated composite channels from all UEs 121 that transmit any RS P1 comprised in the set of RS P1, P2, P3 allocated for the particular data transmission A.

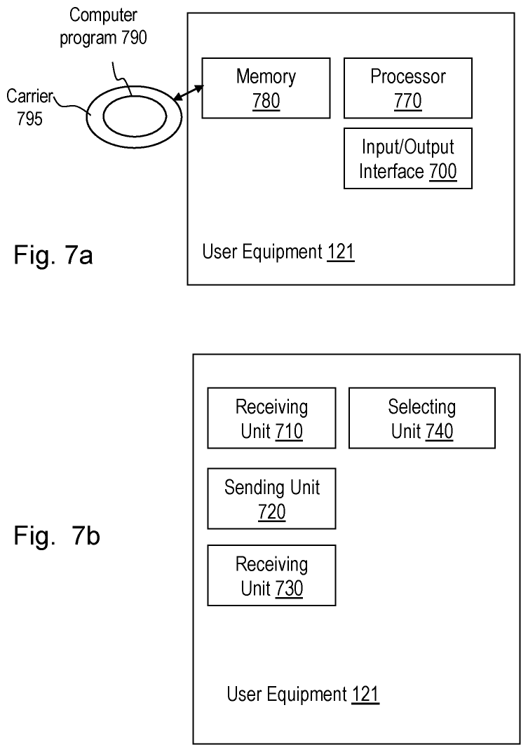

To perform the method actions above for receiving broadcasted beamformed signals of a data transmission from a network node 110, the UE 121 may comprise the arrangement depicted in FIGS. 7a and 7b. As mentioned above, the UE 121 and the network node 110 are adapted to operate in a wireless communication network 100.

The UE 121 may comprise an input and output interface 700 configured to communicate, e.g. with the network node 110. The input and output interface may comprise a wireless receiver (not shown) and a wireless transmitter (not shown).

The UE 121 is configured to, for each specific data transmission A-P1, B-P2, C-P3 out of a number of data transmissions A, B, C, e.g. by means of a receiving unit 710 in the UE 121, receive from the network node 110, an indication of an allocated set of Reference Signals, RS P1, P2, P3 for the data transmission A-P1, B-P2, C-P3. The number of RS in the set of RS is adapted to be based on a measure of popularity for UEs 120 receiving the specific data transmission.

The UE 121 may be configured to receive, e.g. by means of the receiving unit 710, the allocated set of Reference Signals, RS P1, P2, P3 for the data transmission A-P1, B-P2, C-P3, where the RSs P1, P2, P3 are adapted to be allocated such that a utility metric of the particular data transmission A, B, C is adapted.

The UE 121 is further configured to, e.g. by means of a sending unit 720 in the UE 121, send to the network node 110, an RS P1 out of the set of RS P1, P2, P3 allocated for a particular requested data transmission A out of the number of data transmissions.

The UE 121 is further configured to, e.g. by means of a receiving unit 730 in the UE 121, receive from the network node 110, broadcasted beamformed signals of the particular data transmission A. The signals are adapted to be beamformed based on estimated composite channels from all UEs 121 that transmit any RS P1 comprised in the set of RS P1, P2, P3 allocated for the particular data transmission A.

The UE 121 may further be configured to, e.g. by means of a selecting unit 740 in the UE 121, select the RS P1 out of the set of RSs P1, P2, P3 allocated for the particular requested data transmission A out of the number of data transmission A, B, C by any one out of:

Pseudo-random selection,

Selection based on UE identity, and

Selection based on explicit configuration from the network.

The embodiments herein may be implemented through a respective processor or one or more processors, such as a processor 670 of a processing circuitry in the network node 110 depicted in FIG. 6 and a processor 770 of a processing circuitry in the UE 121 depicted in FIG. 7, together with respective computer program code for performing the functions and actions of the embodiments herein. The program code mentioned above may also be provided as a computer program product, for instance in the form of a data carrier carrying computer program code for performing the embodiments herein when being loaded into the network node 110 and/or the UE 121. One such carrier may be in the form of a CD ROM disc. It is however feasible with other data carriers such as a memory stick. The computer program code may furthermore be provided as pure program code on a server and downloaded to the network node 110 and/or the UE 121.

The network node 110 and/or the UE 121 may further comprise a memory 680, 780 comprising one or more memory units. The respective memory 680, 780 comprises instructions executable by the respective processor in the network node 110 and the UE 121.

The memory 680, 780 is arranged to be used to store e.g. data, configurations, and applications to perform the methods herein when being executed in the respective network node 110 and/or UE 121.

In some embodiments, a respective computer program 690, 790 comprises instructions, which when executed by the respective at least one processor 670, 770, cause the at least one processor of the network node 110 and/or the UE 121 to perform the actions above.

In some embodiments, a respective carrier 695, 795 comprises the respective computer program, wherein the carrier is one of an electronic signal, an optical signal, an electromagnetic signal, a magnetic signal, an electric signal, a radio signal, a microwave signal, or a computer-readable storage medium.

### Further Extensions and Variations

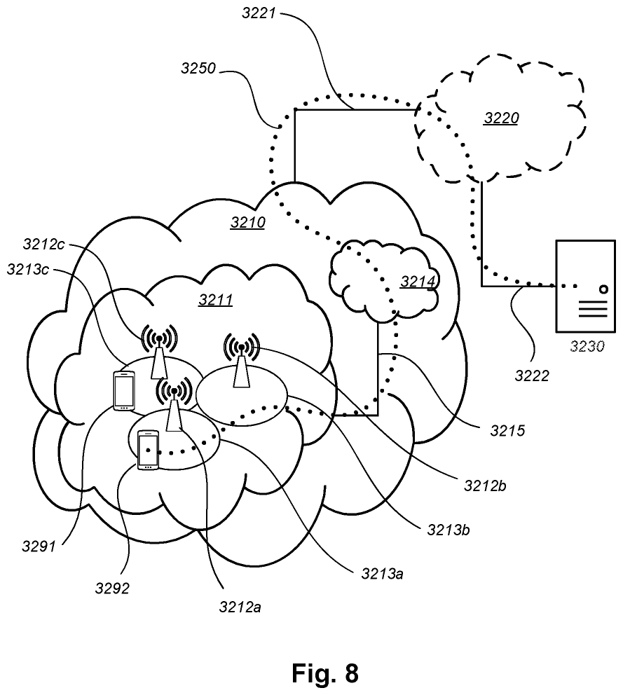

With reference to FIG. 8, in accordance with an embodiment, a communication system includes a telecommunication network 3210 such as the wireless communications network 100, e.g. an IoT network, or a WLAN, such as a 3GPP-type cellular network, which comprises an access network 3211, such as a radio access network, and a core network 3214. The access network 3211 comprises a plurality of base stations 3212a, 3212b, 3212c, such as the network node 110, 130, access nodes, AP STAs NBs, eNBs, gNBs or other types of wireless access points, each defining a corresponding coverage area 3213a, 3213b, 3213c. Each base station 3212a, 3212b, 3212c is connectable to the core network 3214 over a wired or wireless connection 3215. A first user equipment (UE) e.g. the wireless device 120 such as a Non-AP STA 3291 located in coverage area 3213c is configured to wirelessly connect to, or be paged by, the corresponding base station 3212c. A second UE 3292 e.g. the wireless device 122 such as a Non-AP STA in coverage area 3213a is wirelessly connectable to the corresponding base station 3212a. While a plurality of UEs 3291, 3292 are illustrated in this example, the disclosed embodiments are equally applicable to a situation where a sole UE is in the coverage area or where a sole UE is connecting to the corresponding base station 3212.

The telecommunication network 3210 is itself connected to a host computer 3230, which may be embodied in the hardware and/or software of a standalone server, a cloud-implemented server, a distributed server or as processing resources in a server farm. The host computer 3230 may be under the ownership or control of a service provider, or may be operated by the service provider or on behalf of the service provider. The connections 3221, 3222 between the telecommunication network 3210 and the host computer 3230 may extend directly from the core network 3214 to the host computer 3230 or may go via an optional intermediate network 3220. The intermediate network 3220 may be one of, or a combination of more than one of, a public, private or hosted network; the intermediate network 3220, if any, may be a backbone network or the Internet; in particular, the intermediate network 3220 may comprise two or more sub-networks (not shown).

The communication system of FIG. 8 as a whole enables connectivity between one of the connected UEs 3291, 3292 and the host computer 3230. The connectivity may be described as an over-the-top (OTT) connection 3250. The host computer 3230 and the connected UEs 3291, 3292 are configured to communicate data and/or signaling via the OTT connection 3250, using the access network 3211, the core network 3214, any intermediate network 3220 and possible further infrastructure (not shown) as intermediaries. The OTT connection 3250 may be transparent in the sense that the participating communication devices through which the OTT connection 3250 passes are unaware of routing of uplink and downlink communications. For example, a base station 3212 may not or need not be informed about the past routing of an incoming downlink communication with data originating from a host computer 3230 to be forwarded (e.g., handed over) to a connected UE 3291. Similarly, the base station 3212 need not be aware of the future routing of an outgoing uplink communication originating from the UE 3291 towards the host computer 3230.

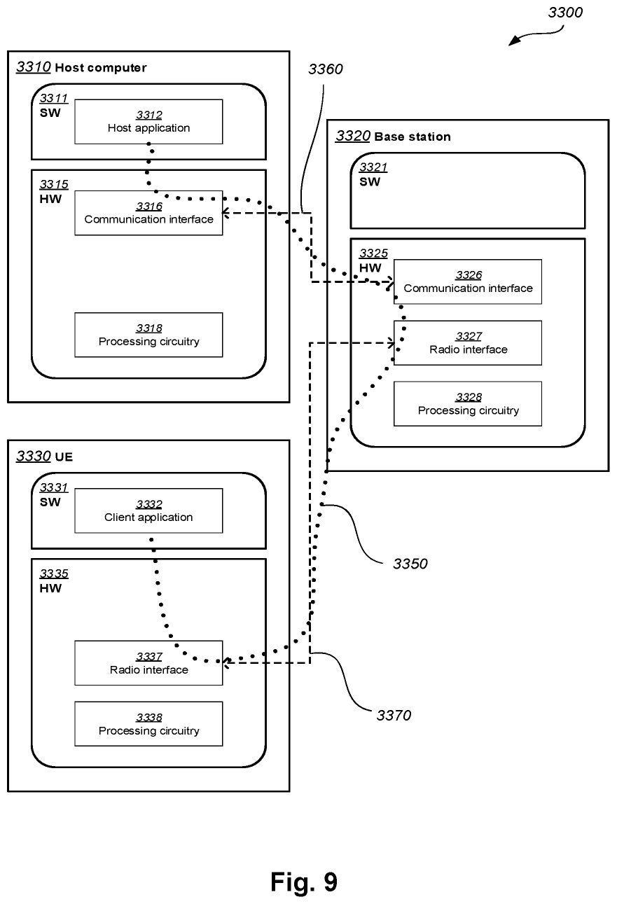

Example implementations, in accordance with an embodiment, of the UE, base station and host computer discussed in the preceding paragraphs will now be described with reference to FIG. 9. In a communication system 3300, a host computer 3310 comprises hardware 3315 including a communication interface 3316 configured to set up and maintain a wired or wireless connection with an interface of a different communication device of the communication system 3300. The host computer 3310 further comprises processing circuitry 3318, which may have storage and/or processing capabilities. In particular, the processing circuitry 3318 may comprise one or more programmable processors, application-specific integrated circuits, field programmable gate arrays or combinations of these (not shown) adapted to execute instructions. The host computer 3310 further comprises software 3311, which is stored in or accessible by the host computer 3310 and executable by the processing circuitry 3318. The software 3311 includes a host application 3312. The host application 3312 may be operable to provide a service to a remote user, such as a UE 3330 connecting via an OTT connection 3350 terminating at the UE 3330 and the host computer 3310. In providing the service to the remote user, the host application 3312 may provide user data which is transmitted using the OTT connection 3350.

The communication system 3300 further includes a base station 3320 provided in a telecommunication system and comprising hardware 3325 enabling it to communicate with the host computer 3310 and with the UE 3330. The hardware 3325 may include a communication interface 3326 for setting up and maintaining a wired or wireless connection with an interface of a different communication device of the communication system 3300, as well as a radio interface 3327 for setting up and maintaining at least a wireless connection 3370 with a UE 3330 located in a coverage area (not shown) served by the base station 3320. The communication interface 3326 may be configured to facilitate a connection 3360 to the host computer 3310. The connection 3360 may be direct or it may pass through a core network (not shown in FIG. 9) of the telecommunication system and/or through one or more intermediate networks outside the telecommunication system. In the embodiment shown, the hardware 3325 of the base station 3320 further includes processing circuitry 3328, which may comprise one or more programmable processors, application-specific integrated circuits, field programmable gate arrays or combinations of these (not shown) adapted to execute instructions. The base station 3320 further has software 3321 stored internally or accessible via an external connection.

The communication system 3300 further includes the UE 3330 already referred to. Its hardware 3335 may include a radio interface 3337 configured to set up and maintain a wireless connection 3370 with a base station serving a coverage area in which the UE 3330 is currently located. The hardware 3335 of the UE 3330 further includes processing circuitry 3338, which may comprise one or more programmable processors, application-specific integrated circuits, field programmable gate arrays or combinations of these (not shown) adapted to execute instructions. The UE 3330 further comprises software 3331, which is stored in or accessible by the UE 3330 and executable by the processing circuitry 3338. The software 3331 includes a client application 3332. The client application 3332 may be operable to provide a service to a human or non-human user via the UE 3330, with the support of the host computer 3310. In the host computer 3310, an executing host application 3312 may communicate with the executing client application 3332 via the OTT connection 3350 terminating at the UE 3330 and the host computer 3310. In providing the service to the user, the client application 3332 may receive request data from the host application 3312 and provide user data in response to the request data. The OTT connection 3350 may transfer both the request data and the user data. The client application 3332 may interact with the user to generate the user data that it provides.

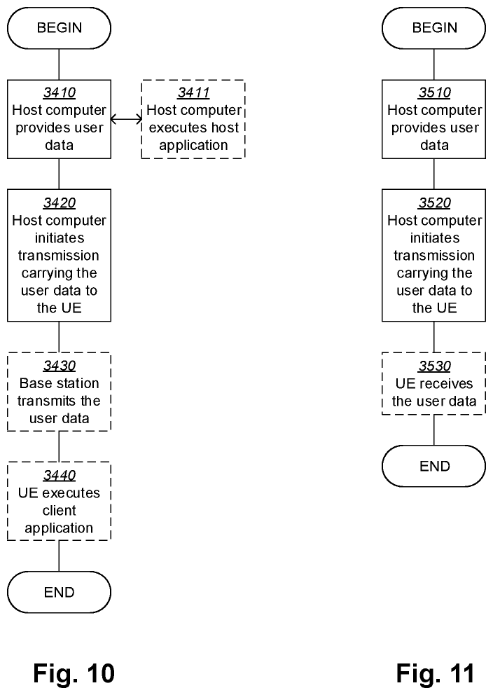

It is noted that the host computer 3310, base station 3320 and UE 3330 illustrated in FIG. 9 may be identical to the host computer 3230, one of the base stations 3212a, 3212b, 3212c and one of the UEs 3291, 3292 of FIG. 10, respectively. This is to say, the inner workings of these entities may be as shown in FIG. 9 and independently, the surrounding network topology may be that of FIG. 8.

In FIG. 9, the OTT connection 3350 has been drawn abstractly to illustrate the communication between the host computer 3310 and the use equipment 3330 via the base station 3320, without explicit reference to any intermediary devices and the precise routing of messages via these devices. Network infrastructure may determine the routing, which it may be configured to hide from the UE 3330 or from the service provider operating the host computer 3310, or both. While the OTT connection 3350 is active, the network infrastructure may further take decisions by which it dynamically changes the routing (e.g., on the basis of load balancing consideration or reconfiguration of the network).

The wireless connection 3370 between the UE 3330 and the base station 3320 is in accordance with the teachings of the embodiments described throughout this disclosure. One or more of the various embodiments improve the performance of OTT services provided to the UE 3330 using the OTT connection 3350, in which the wireless connection 3370 forms the last segment. More precisely, the teachings of these embodiments may improve the applicable RAN effect: data rate, latency, power consumption, and thereby provide benefits such as corresponding effect on the OTT service: e.g. reduced user waiting time, relaxed restriction on file size, better responsiveness, extended battery lifetime.

A measurement procedure may be provided for the purpose of monitoring data rate, latency and other factors on which the one or more embodiments improve. There may further be an optional network functionality for reconfiguring the OTT connection 3350 between the host computer 3310 and UE 3330, in response to variations in the measurement results. The measurement procedure and/or the network functionality for reconfiguring the OTT connection 3350 may be implemented in the software 3311 of the host computer 3310 or in the software 3331 of the UE 3330, or both. In embodiments, sensors (not shown) may be deployed in or in association with communication devices through which the OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of the OTT connection 3350 may include message format, retransmission settings, preferred routing etc.; the reconfiguring need not affect the base station 3320, and it may be unknown or imperceptible to the base station 3320. Such procedures and functionalities may be known and practiced in the art. In certain embodiments, measurements may involve proprietary UE signaling facilitating the host computer's 3310 measurements of throughput, propagation times, latency and the like. The measurements may be implemented in that the software 3311, 3331 causes messages to be transmitted, in particular empty or ‘dummy’ messages, using the OTT connection 3350 while it monitors propagation times, errors etc.

FIG. 10 is a flowchart illustrating a method implemented in a communication system, in accordance with one embodiment. The communication system includes a host computer, a base station such as the network node 110, and a UE such as the wireless device 120, which may be those described with reference to FIG. 8 and FIG. 9. For simplicity of the present disclosure, only drawing references to FIG. 10 will be included in this section. In a first action 3410 of the method, the host computer provides user data. In an optional subaction 3411 of the first action 3410, the host computer provides the user data by executing a host application. In a second action 3420, the host computer initiates a transmission carrying the user data to the UE. In an optional third action 3430, the base station transmits to the UE the user data which was carried in the transmission that the host computer initiated, in accordance with the teachings of the embodiments described throughout this disclosure. In an optional fourth action 3440, the UE executes a client application associated with the host application executed by the host computer.

FIG. 11 is a flowchart illustrating a method implemented in a communication system, in accordance with one embodiment. The communication system includes a host computer, a base station such as a AP STA, and a UE such as a Non-AP STA which may be those described with reference to FIG. 8 and FIG. 9. For simplicity of the present disclosure, only drawing references to FIG. 11 will be included in this section. In a first action 3510 of the method, the host computer provides user data. In an optional subaction (not shown) the host computer provides the user data by executing a host application. In a second action 3520, the host computer initiates a transmission carrying the user data to the UE. The transmission may pass via the base station, in accordance with the teachings of the embodiments described throughout this disclosure. In an optional third action 3530, the UE receives the user data carried in the transmission.

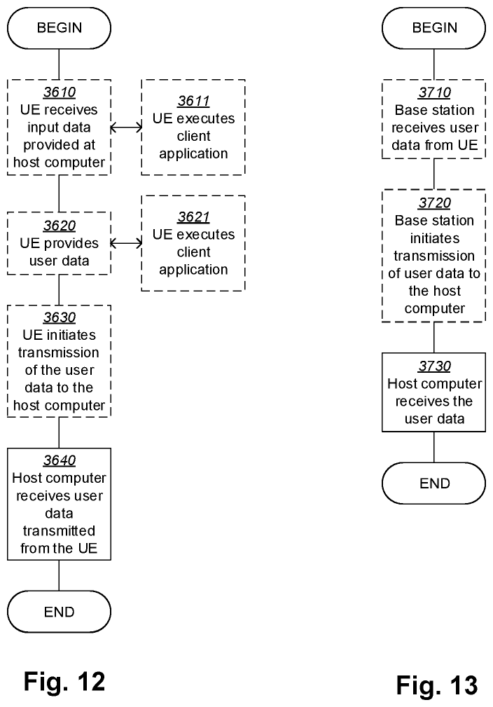

FIG. 12 is a flowchart illustrating a method implemented in a communication system, in accordance with one embodiment. The communication system includes a host computer, a base station such as a AP STA, and a UE such as a Non-AP STA which may be those described with reference to FIG. 8 and FIG. 9. For simplicity of the present disclosure, only drawing references to FIG. 12 will be included in this section. In an optional first action 3610 of the method, the UE receives input data provided by the host computer. Additionally or alternatively, in an optional second action 3620, the UE provides user data. In an optional subaction 3621 of the second action 3620, the UE provides the user data by executing a client application. In a further optional subaction 3611 of the first action 3610, the UE executes a client application which provides the user data in reaction to the received input data provided by the host computer. In providing the user data, the executed client application may further consider user input received from the user. Regardless of the specific manner in which the user data was provided, the UE initiates, in an optional third subaction 3630, transmission of the user data to the host computer. In a fourth action 3640 of the method, the host computer receives the user data transmitted from the UE, in accordance with the teachings of the embodiments described throughout this disclosure.

FIG. 13 is a flowchart illustrating a method implemented in a communication system, in accordance with one embodiment. The communication system includes a host computer, a base station such as a AP STA, and a UE such as a Non-AP STA which may be those described with reference to FIG. 8 and FIG. 9. For simplicity of the present disclosure, only drawing references to FIG. 13 will be included in this section. In an optional first action 3710 of the method, in accordance with the teachings of the embodiments described throughout this disclosure, the base station receives user data from the UE. In an optional second action 3720, the base station initiates transmission of the received user data to the host computer. In a third action 3730, the host computer receives the user data carried in the transmission initiated by the base station.

When using the word “comprise” or “comprising” it shall be interpreted as non-limiting, i.e. meaning “consist at least of”.

The embodiments herein are not limited to the above described preferred embodiments. Various alternatives, modifications and equivalents may be used.

1. A method performed by a network node for broadcasting beamformed signals of a data transmission to a User Equipment, UE, which network node and UE operate in a wireless communication network, the method comprising:
for each specific data transmission out of a number of data transmissions, allocating a set of Reference Signals, RS for the data transmission, the number of RS in the set of RS being based on a measure of popularity for UEs receiving the specific data transmission;
sending to UEs an indication of the allocated set of SRs for each specific data transmission;
receiving from a UE requesting a particular data transmission out of the number of data transmissions, an RS out of the set of RS allocated for the particular data transmission; and
broadcasting beamformed signals of the particular data transmission, which signals are beamformed based on estimated composite channels from all UEs that transmit any RS comprised in the set of RS allocated for the particular data transmission.

2. The method according to claim 1, wherein allocating a set of Reference Signals, RS for the data transmission, further comprises:
allocating the RSs for the data transmission such that a utility metric of the particular data transmission is adapted.

3. The method according to claim 1, wherein:
for each specific data transmission out of the number of data transmissions, obtaining a measure of popularity for UEs receiving the specific data transmission, and statistical channel information of the UEs.

4. The method according to claim 3, further comprising:
dividing the UEs into a number of groups based on the statistical channel information of the UEs; and
for each set of RSs out of the allocated sets of RSs, assigning different RS for different groups of UEs to adapt a utility metric of the particular data transmission.

5. (canceled)

6. (canceled)

7. A method performed by a User Equipment, UE, for receiving broadcasted beamformed signals of a data transmission from a network node, which UE and network node operate in a wireless communication network, the method comprising:
for each specific data transmission out of a number of data transmissions, receiving from the network node an indication of an allocated set of Reference Signals, RS for the data transmission, the number of RS in the set of RS being based on a measure of popularity for UEs receiving the specific data transmission;
sending to the network node, an RS out of the set of RS allocated for a particular requested data transmission out of the number of data transmissions; and
receiving, from the network node, broadcasted beamformed signals of the particular data transmission, which signals are beamformed based on estimated composite channels from all UEs that transmit any RS comprised in the set of RS allocated for the particular data transmission.

8. The method according to claim 7, wherein:
the allocated set of Reference Signals, RS for the data transmission are allocated such that a utility metric of the particular data transmission is adapted.

9. The method according to claim 7, further comprising:
selecting the RS out of the set of RS allocated for the particular requested data transmission out of the number of data transmission by any one out of:
Pseudo random pseudo-random selection;
selection based on UE identity; and
selection based on explicit configuration from the network.

10. (canceled)

11. (canceled)

12. A network node for broadcasting beamformed signals of a data transmission to a User Equipment, UE, which network node and UE are adapted to operate in a wireless communication network, the network node being configured to:
for each specific data transmission out of a number of data transmissions, allocate a set of Reference Signals, RS for the data transmission, the number of RS in the set of RS being adapted to be based on a measure of popularity for UEs receiving the specific data transmission;
send to UEs an indication of the allocated set of SRs for each specific data transmission;
receive from a UE requesting a particular data transmission out of the number of data transmissions, an RS out of the set of RS (P1, P2, P3) allocated for the particular data transmission; and
broadcast beamformed signals of the particular data transmission, which signals are adapted to be beamformed based on estimated composite channels from all UEs that transmit any RS comprised in the set of RS allocated for the particular data transmission.

13. The network node according to claim 12, wherein the network node is configured to allocate a set of Reference Signals, RS for the data transmission, by further being configured to:
allocate the RSs for the data transmission such that a utility metric of the particular data transmission is adapted.

14. The network node according to claim 12, wherein the network node is further configured to:
for each specific data transmission out of the number of data transmissions, obtain a measure of popularity for UEs receiving the specific data transmission, and statistical channel information of the UEs.

15. The network node according to claim 14, wherein the network node is further configured to:
divide the UEs into a number of groups based on the statistical channel information of the UEs; and
for each set of RSs out of the allocated sets of RSs, assign different RS for different groups of UEs to adapt a utility metric of the particular data transmission.

16. A User Equipment, UE, for receiving broadcasted beamformed signals of a data transmission from a network node, which UE and network node are adapted to operate in a wireless communication network, the UE being configured to:
for each specific data transmission out of a number of data transmissions, receive from the network node, an indication of an allocated set of Reference Signals, RS for the data transmission, the number of RS in the set of RS being adapted to be based on a measure of popularity for UEs receiving the specific data transmission;
send to the network node, an RS out of the set of RS allocated for a particular requested data transmission out of the number of data transmissions; and
receive from the network node, broadcasted beamformed signals of the particular data transmission, which signals are adapted to be beamformed based on estimated composite channels from all UEs that transmit any RS comprised in the set of RS allocated for the particular data transmission.

17. The UE according to claim 16, wherein:
the allocated set of Reference Signals, RS for the data transmission are adapted to be allocated such that a utility metric of the particular data transmission is adapted.

18. The UE according to claim 16, the UE being further configured to:
select the RS out of the set of RS allocated for the particular requested data transmission out of the number of data transmission by any one out of:
pseudo-random selection;
selection based on UE identity; and
selection based on explicit configuration from the network.

19. The method according to claim 2, wherein:
for each specific data transmission out of the number of data transmissions, obtaining a measure of popularity for UEs receiving the specific data transmission, and statistical channel information of the UEs.

20. The method according to claim 3, further comprising:
dividing the UEs into a number of groups based on the statistical channel information of the UEs; and
for each set of RSs out of the allocated sets of RSs, assigning different RS for different groups of UEs to adapt a utility metric of the particular data transmission.

21. The method according to claim 8, further comprising:
selecting the RS out of the set of RS allocated for the particular requested data transmission out of the number of data transmission by any one out of:
pseudo-random selection;
selection based on UE identity; and
selection based on explicit configuration from the network.

22. The network node according to claim 13, wherein the network node is further configured to:
for each specific data transmission out of the number of data transmissions, obtain a measure of popularity for UEs receiving the specific data transmission, and statistical channel information of the UEs.

23. The network node according to claim 22, wherein the network node is further configured to:
divide the UEs into a number of groups based on the statistical channel information of the UEs; and
for each set of RSs out of the allocated sets of RSs, assign different RS for different groups of UEs to adapt a utility metric of the particular data transmission.

24. The UE according to claim 17, the UE being further configured to:
select the RS out of the set of RS allocated for the particular requested data transmission out of the number of data transmission by any one out of:
pseudo-random selection;
selection based on UE identity; and
selection based on explicit configuration from the network.
